(19) United States
(12) Patent Application Publication
(10) Pub. No.: US 2019/0115630 A1
(43) Pub. Date: Apr. 18, 2019

(54) BATTERY LIFE EXTENDERS

(71) Applicant: Batteroo, Inc., Sunnyvale, CA (US)

(72) Inventors: Fariborz Frankie Roohparvar, Monte Sereno, CA (US); Farzan Bob Roohparvar, Los Gatos, CA (US)

(73) Assignee: Batteroo, Inc., Sunnyvale, CA (US)

(21) Appl. No.: 16/090,479

(22) PCT Filed: Mar. 31, 2017
(86) PCT No.: PCT/US2017/025542

§ 371 Date: Oct. 1, 2018

Related U.S. Application Data
(60) Provisional application No. 62/316,134, filed on Mar. 31, 2016.

(51) Int. Cl. H01M 10/42; H02J 7/00; H01M 6/50; H01M 2/10; H01M 10/44

(52) U.S. Cl. CPC H01M 10/4257; H02J 7/0065; H01M 6/5011; H02M 3/156; H01M 2/1061; H01M 10/441; H01M 2/105

(57) ABSTRACT

Battery life extending devices include a voltage boosting circuit that generates a boosted voltage from an insufficiently high battery output voltage. A voltage boosting circuit can employ voltage bypass to output the battery voltage when the battery outputs a sufficiently high voltage for the operation of a battery powered device. A voltage boosting circuit can reduce output voltage in response to reduced input voltage from the battery.

### CROSS-REFERENCE TO RELATED APPLICATIONS

This application claims the benefit of U.S. Provisional Application No. 62/316,134, filed Mar. 31, 2016, which is incorporated herein by reference in its entirety for all purposes.

### BACKGROUND

The invention relates in general to battery technology and more particularly to techniques for extending the operational life of batteries such as disposable and rechargeable batteries. Most consumer electronic equipment use batteries. Many electronic equipment require precise voltages to operate properly. In some cases, if the voltage supplied to the electronic equipment drops too low, the equipment may produce unreliable output and the low voltage may also damage the equipment. As such, many manufacturers of electronic equipment include circuitry that detects battery voltage levels and turns the equipment off if the voltage level drops below a certain level.

Some electronic equipment that use disposable batteries, such as AA batteries, are designed to stop operating when the battery voltage drops by 10% or so. With such equipment, when the voltage of an AA battery drops to about 1.4 volts or 1.35 volts, the battery is no longer useable by the equipment and has to be replaced with a fresh battery. Thus, the entire voltage range between 0 volts to 1.35 volts is wasted, resulting in significant inefficiency. This is akin to the scenario where only 10% of a soda bottle is consumed, as a matter of routine, and the rest discarded. This clearly would be very wasteful and inefficient. There are also devices that have lower cut off voltages, in turn using more of the battery's stored energy. The batteries powering such devices, however, can prematurely output voltage below the cutoff voltage due to surges of current used by such devices in combination with the internal resistance of the battery.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Battery life extension units and related replacement battery assemblies and sleeves are described that enable more complete usage of power stored in a battery, such as disposable or rechargeable batteries. A battery life extension unit includes a voltage regulation controller configured to generate a regulated output voltage from an input voltage supplied by the battery. The voltage regulation controller is configured so that the regulated output voltage is kept at a sufficiently high level suitable for powering the battery powered device even when the input voltage from the battery is below a level sufficient for powering the battery powered device. As a result, the battery life extension unit extracts previously unavailable power from the battery, thereby extending the operational life of the battery.

Thus, in one aspect, a battery life extension unit is provided. The battery life extension unit includes a voltage-boosting regulation circuit, a positive output terminal, a positive input terminal, and a ground input terminal. The voltage-boosting regulation circuit is configured to produce a regulated output voltage from an input voltage supplied by a battery cell. The regulated output voltage is greater than the input voltage when the input voltage is less than a predetermined voltage. The positive output terminal is configured to supply the regulated output voltage to a battery powered device. The positive input terminal is configured to receive the input voltage from the battery cell. The ground input terminal is electrically coupled with the voltage-boosting regulation circuit.

In many embodiments, the regulated output voltage is equal to or greater than a minimum voltage necessary for proper operation of the battery powered device when the input voltage is at a low voltage level. For example, the voltage-boosting regulation circuit can be configured so that the regulated output voltage is equal to or greater than 1.2 volts when the input voltage is about 0.5 volts. As another example, the voltage-boosting regulation circuit can be configured so that the regulated output voltage is equal to or greater than 1.4 volts when the input voltage is about 0.5 volts.

The battery life extension unit can include a support frame that supports the positive output terminal, the positive input terminal, and the ground input terminal in suitable locations for use in receiving power from the battery and supplying the regulated output voltage to the battery powered device. For example, the positive output terminal can be attached to the support frame so as to be positioned, relative to a ground terminal of the battery cell, to interface with a positive input terminal of the battery powered device to supply the regulated output voltage to the battery powered device when a ground input terminal of the battery powered device is interfaced with the ground terminal of the battery cell. The positive input terminal can be attached to the support frame so as to be positioned, relative to the ground terminal of the battery cell, to interface with a positive terminal of the battery cell to receive the input voltage when the ground input terminal of the battery powered device is interfaced with the ground terminal of the battery cell. The ground input terminal can be attached to the support frame so as to be positioned to interface with the ground terminal of the battery cell when the ground input terminal of the battery powered device is interfaced with the ground terminal of the battery cell.

The battery life extension unit can include a tangible memory device or contain memory internal to the power management circuitry for storing data and/or operational parameters. For example, the tangible memory device can store an output voltage lookup table defining the regulated output voltage as a function of the input voltage. The output voltage lookup table can be programmable by a user of the battery life extension unit. The tangible memory device can store (a) an active-load device output voltage lookup table defining the regulated output voltage, as a function of the input voltage, so as to be suitable for operation of an active-load battery powered device, and (b) a passive-load device output voltage lookup table defining the regulated output voltage, as a function of the input voltage, so as to be suitable for operation of a passive-load battery powered device. The active-load device output voltage lookup table can define the regulated output voltage to be in a range of 1.1 volts to 1.4 volts when the input voltage is in a range of 0.8 volts to 1.6 volts. The passive-load device output voltage lookup table can define the regulated output voltage to be equal to or greater than 1.4 volts when the input voltage is in a range of 0.8 volts to 1.6 volts.

The battery life extension unit can include a mode selection mechanism operable to select a mode of operation, whereby depending on the mode of operation selected, the regulated output voltage can be selected as a function of the input voltage. The mode selection mechanism can be implemented via software via which a user selection of the mode of operation is made, or can include one or more configuration switches operable by a user to make the mode of operation selection. An output voltage transition table can be programmable by a user of the battery life extension unit. The battery life extension unit can be configured to operate in a selected mode of operation from different operational modes, which can include operational modes in which (a) an active-load device output voltage transition table defines the regulated output voltage, as a function of the input voltage, so as to be suitable for operation of an active-load battery powered device, and (b) a passive-load device output voltage transition table defines the regulated output voltage, as a function of the input voltage, so as to be suitable for operation of a passive-load battery powered device. The active-load device output voltage transition table can define the regulated output voltage to be in a range of 1.1 volts to 1.4 volts when the input voltage is in a range of 0.8 volts to 1.6 volts. The passive-load device output voltage transition table can define the regulated output voltage to be equal to or greater than 1.4 volts when the input voltage is in a range of 0.8 volts to 1.6 volts.

The battery life extension unit can be configured so that a user can select from a plurality of operational modes including a rechargeable battery operational mode. The rechargeable battery operational mode can be suitable for use with a rechargeable battery and have a rechargeable battery stop input voltage level that prevents discharge of the rechargeable battery below the rechargeable battery stop input voltage level. In many embodiments, the rechargeable battery stop input voltage level is suitable to prevent damage to the rechargeable battery associated with excessive discharge of the rechargeable battery.

In some embodiments, the regulated output voltage is equal to the input voltage when the input voltage is above a pass-through voltage threshold. In some embodiments, the pass-through voltage threshold is programmable by a user of the battery life extension unit.

The battery life extension unit can include a wireless communication unit. In some embodiments, the wireless communication unit is operable to transmit at least one of: (a) a state of charge of the battery cell, and (b) an estimated time remaining for operation of the battery powered device via power supplied by the battery cell. In some embodiments, the wireless communication unit is operable to (a) receive data from the battery powered device; and (b) transmit the data received from the battery powered device. The manner in which the transmit of the data occurs can be based on a protocol that is either proprietary or public.

The wireless communication unit can be used in the Internet Of Things, IoT, applications. There are specific protocols used for these types of communication. IoT applications are becoming more and more used and are expanding to the outer portions of the web. These types of applications are more battery powered, such as electronic locks. An electronic lock, for example, can communicate a notification to an IOT application that a battery for the electronic lock has a low state of charge. Having the IoT protocol as a part of the wireless communication unit allows a lot of devices to become IoT capable through use of power management. Additionally, these devices can use the wireless communication unit to transmit other types of data in an IoT capable device. So a dumb device can become IoT enabled through use of the battery life extension unit.

The battery life extension unit can be configured to be reusable with different battery cells. For example, the battery life extension unit can be configured to be removably connectable to a battery cell to enable reuse with at least two different battery cells. The removable battery life extension unit or a removable communication unit can be in form of a card that slides into the battery or can be screwed onto or into the battery. In some embodiments, a battery that is capable of using the removable and/or reusable battery life extension unit can be sold with the removeable and/or reusable battery life extension unit or without. In this embodiment, a user of such a battery can buy a more expensive unit with the removable and/or reusable battery life extension unit, then buy a less expensive battery without such unit and use the battery life extension unit from a battery that has exhausted its charge.

The battery life extension unit can be incorporated into any suitable assembly, such as any of the battery sleeves and battery replacement assemblies described herein. The battery life extension unit can also be incorporated into any suitable battery powered device to generate a regulated output voltage that is supplied to power the battery powered device from an input voltage supplied by one or more batteries.

In another aspect, a 9 volt battery replacement assembly is provided. The 9 volt battery replacement assembly includes a voltage-boosting regulation circuit, an outer shell, and positive and negative terminals. The voltage-boosting regulation circuit is configured to produce a 9 volt output voltage from two or more 1.5 volt batteries. The voltage-boosting regulation circuit can include the battery life extension unit described herein. The outer shell is configured to at least partially enclose the two or more 1.5 volt batteries. The positive and negative terminals are configured to interface with a 9 volt input connector of an electrical device configured to be powered by a 9 volt battery.

In another aspect, a battery replacement assembly for replacing a D size battery is provided. The battery replacement assembly includes a voltage-boosting regulation circuit, an outer shell, and positive and negative output terminals. The voltage-boosting regulation circuit is configured to produce a regulated output voltage from an input voltage supplied by three AA size batteries connected in parallel. The regulated output voltage is greater than the input voltage when the input voltage is less than a predetermined voltage. The voltage-boosting regulation circuit can include the battery life extension unit described herein. The outer shell is configured to at least partially enclose the three AA size batteries. The positive and negative output terminals are configured for outputting the regulated output voltage. The positive and negative output terminals are attached to the shell so as to be positioned to match positioning of positive and negative output terminals for a D size battery.

In another aspect, a battery replacement assembly for replacing a C size battery is provided. The battery replacement assembly includes a voltage-boosting regulation circuit, an outer shell, and positive and negative output terminals. The voltage-boosting regulation circuit is configured to produce a regulated output voltage from an input voltage supplied by four AAA size batteries connected in parallel. The regulated output voltage is greater than the input voltage when the input voltage is less than a predetermined voltage. The voltage-boosting regulation circuit can include the battery life extension unit described herein. The outer shell is configured to at least partially enclose the four AAA size batteries. The positive and negative output terminals are configured for outputting the regulated output voltage. The positive and negative output terminals are attached to the shell so as to be positioned to match positioning of positive and negative output terminals for a C size battery.

In another aspect, a battery life extending sleeve is provided. The battery life extending sleeve includes a voltage-boosting regulation circuit, a sleeve, and a Flexible Electrical Contact (FEC). The voltage-boosting regulation circuit can include the battery life extension unit described herein. The sleeve is configured to electrically connect positive and negative terminals of a battery to the voltage-boosting regulation circuit. The FEC is electrically connected to a positive voltage output of the voltage-boosting regulation circuit. The FEC is configured to flex toward the sleeve when interfaced with a mating terminal to accommodate the position of the mating terminal.

For a fuller understanding of the nature and advantages of the present invention, reference should be made to the ensuing detailed description and accompanying drawings.

### BRIEF DESCRIPTION OF THE DRAWINGS

FIG. 1 is a simplified schematic diagram illustrating a battery life extension unit, in accordance with many embodiments.

FIG. 2 is a simplified schematic diagram illustrating a voltage regulation circuit, in accordance with many embodiments, that can be used in the battery life extension unit of FIG. 1.

FIG. 3 is a simplified schematic diagram illustrating an integrated circuit, in accordance with many embodiments, that can be used in the voltage regulation circuit of FIG. 2.

FIG. 4 illustrates a voltage regulation approach utilizing both voltage pass through and voltage increase relative to battery output voltage, in accordance with many embodiments.

FIG. 5 illustrates an example output voltage lookup table, in accordance with many embodiments, that can be used in the battery life extension unit of FIG. 1 to control the level of Vout as a function of Vin.

FIG. 6 illustrates another example output voltage lookup table, in accordance with many embodiments, that can be used in the battery life extension unit of FIG. 1 to control the level of Vout as a function of Vin suitable for use in an active load condition.

FIG. 7 illustrates another example output voltage lookup table, in accordance with many embodiments, that can be used in the battery life extension unit of FIG. 1 to control the level of Vout as a function of Vin suitable for use with rechargeable batteries in a passive load condition.

FIG. 8 is an exploded view illustrating a 9 volt battery replacement assembly that employs two AAA batteries and a voltage-boosting regulation unit, in accordance with many embodiments.

FIG. 9 shows a cross-sectional view of the 9 volt battery replacement assembly of FIG. 8.

FIG. 10 shows a side view of the 9 volt battery replacement assembly of FIG. 8.

FIG. 11 illustrates a 9 volt battery replacement assembly that includes a sliding bottom cover, in accordance with many embodiments.

FIG. 12 illustrates contacts designed to allow the sliding bottom cover of FIG. 11 to slide in from the side.

FIG. 13 is an exploded view illustrating a 9 volt battery replacement assembly that employs three AAA batteries and a voltage-boosting regulation unit, in accordance with many embodiments.

FIG. 14 is a three-dimensional view illustrating the 9 volt battery replacement assembly of FIG. 13.

FIG. 15 is a three-dimensional view illustrating a D-size battery replacement assembly that employs three AA batteries and includes a voltage-boosting regulation unit, in accordance with many embodiments.

FIG. 16 is a three-dimensional view illustrating a battery assembly that employs a reusable voltage-boosting regulation unit, in accordance with many embodiments.

FIG. 17 illustrates a voltage regulating battery sleeve, in accordance with many embodiments.

FIG. 18 shows a top view of the battery sleeve of FIG. 17.

FIG. 19 illustrates a flexible terminal contact for the battery sleeve of FIG. 17.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Battery Life Extension

Embodiments described herein relate to battery life extension devices that include a boost DC to DC converter circuit that generates a controlled voltage output from the output of a battery to extend the useful life of the battery by maximizing the amount of electrical power extracted from the battery. As the battery output voltage ranges from a maximum voltage (e.g., 1.5 to 1.6 volts) to a minimum voltage (e.g., about 0.5 volts), the boost DC to DC converter circuit generates a usable regulated output voltage that exceeds the battery output voltage when the battery output voltage is below a usable voltage. For example, in a typical alkaline-based battery, the fully charged voltage is 1.5 to 1.6 volts and the battery will discharge down to about 0.5 volts most if not all of the energy of the battery is depleted. In many embodiments, the boost DC to DC converter circuit generates an output voltage that varies from 1.5 volts down to about 1.1 or 1.2 volts while the battery discharges from its fully charged state (e.g., 1.5 to 1.6 volts) down to its fully depleted state (e.g., about 0.5 volts). The battery life extension devices described herein can be used to fully drain a battery before the battery is removed and recharged or recycled. The boost DC to DC converter circuit provides a means to fully discharge the battery while providing a fully optimized output voltage for a battery powered device.

The boost DC to DC converter circuit can be configured to generate an output voltage suitable for a particular battery powered device. Many battery powered devices require about 1.1 volts minimum for good operation. Below this voltage, a battery powered device may potentially shut down or not operate at its full capability. For example, a battery-powered tooth brush may not operate at full rate below 1.25 volts. A flashlight may dim below 1.2 volts. A toy may not operate at full rate below 1.3 volts. To account for the variation in possible minimum voltage, the boost DC to DC converter circuit can be configured to generate a minimum voltage suitable for operation of the particular battery powered device.

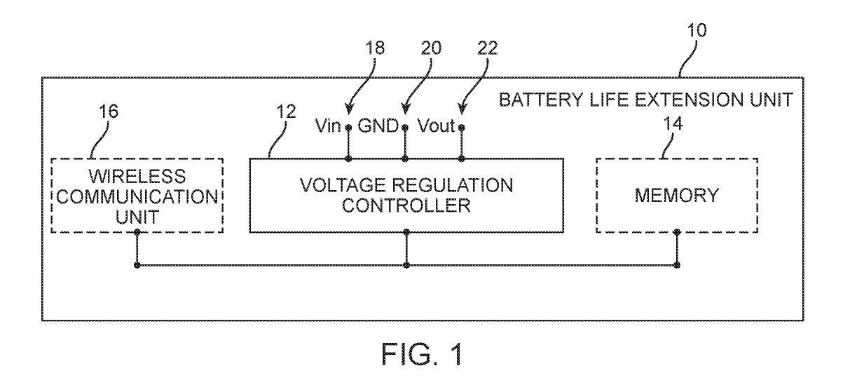

Referring now to the drawings, in which like reference numerals represent like parts throughout the several views, FIG. 1 shows a simplified schematic diagram illustrating a battery life extension unit 10, in accordance with many embodiments. The battery life extension unit 10 includes a voltage regulation controller 12, and can optionally include a tangible memory 14 and/or a wireless communication unit 16.

The voltage regulation controller 12 is configured to receive an input voltage from one or more battery cells via a Vin input terminal 18 and a ground terminal 20. The voltage regulation controller 12 uses the input voltage to generate a regulated output voltage that is output via a Vout output terminal 22 and the ground terminal 20.

The memory 14 is communicatively coupled with the voltage regulation controller 12. The memory 14 can be used to store one or more output voltage lookup tables defining the regulated output voltage as a function of the input voltage for use by the voltage regulation controller 12 in controlling the voltage level of the regulated output voltage. The memory 14 can be used to store any suitable data, such as state of charge of the battery providing the input voltage, power usage levels for the device powered via the regulated output voltage, and/or estimated remaining operational time for the device powered via the regulated output voltage. The memory 14 can also store any suitable parameter used to control operation of the voltage regulation controller 12 including a pass through voltage threshold value as described herein, and/or a battery type parameter.

The wireless communication unit 16 is communicatively coupled with the voltage regulation controller 12 and can be operable to transmit a state of charge of one or more batteries providing the input voltage to the voltage regulation controller 12 and/or an estimate time remaining for operation of a device being powered via the regulated output voltage. In some embodiments, the wireless communication unit 16 is configured to receive data from the device being powered by the regulated output voltage, for example, via short range wireless communication, and transmit the data received from the battery powered device to an external device. The wireless communication unit 16 can be used to implement Internet of Things (IoT) features in the battery life extension unit 10. Accordingly, the battery life extension unit 10 enables devices that typically need batteries to be connected to IoT. Accordingly, the battery life extension unit 10 can be configured to function as an IoT enabled power management system that can transfer data about battery capacity, battery state of charge, power usage of the battery powered device, and/or other types of data related to the battery operated device. The data can be transmitted by the wireless communication unit 16 using a data payload protocol that both the battery powered device and the IoT network can comprehend.

The battery life extension unit 10 can be incorporated into any suitable assembly, such as any of the battery sleeves and battery replacement assemblies described herein. The battery life extension unit 10 can also be incorporated into any suitable battery powered device. For example, the battery powered device an incorporate the battery life extension unit 10 so that an input voltage from one or more battery cells is received by the voltage regulation controller 12 via the Vin input terminal 18 and the ground terminal 20. The regulated output voltage that is generated by the voltage regulation controller 12 and output via the Vout output terminal 22 and the ground terminal 20 can then be used to power the battery powered device. By incorporating the battery life extension unit 10 into the battery powered device, the benefits of the battery life extension unit 10 can be realized without incorporation of the battery life extension unit into the battery, a battery sleeve, or a battery replacement assembly. The battery life extension unit 10 can include any of the features and related functionality described herein including, for example, but not limited to selectable and/or programmable pass through voltage threshold, selectable and/or programmable Vin/Vout lookup table(s), ability to set low voltage range, wireless communication unit and related features and functionality, etc.

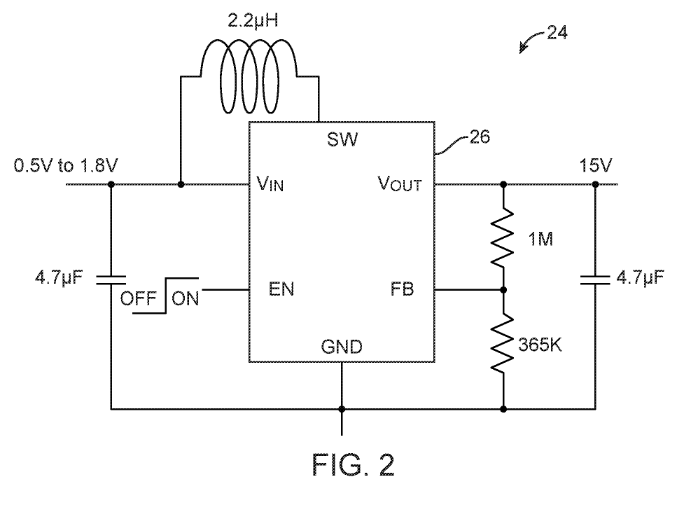

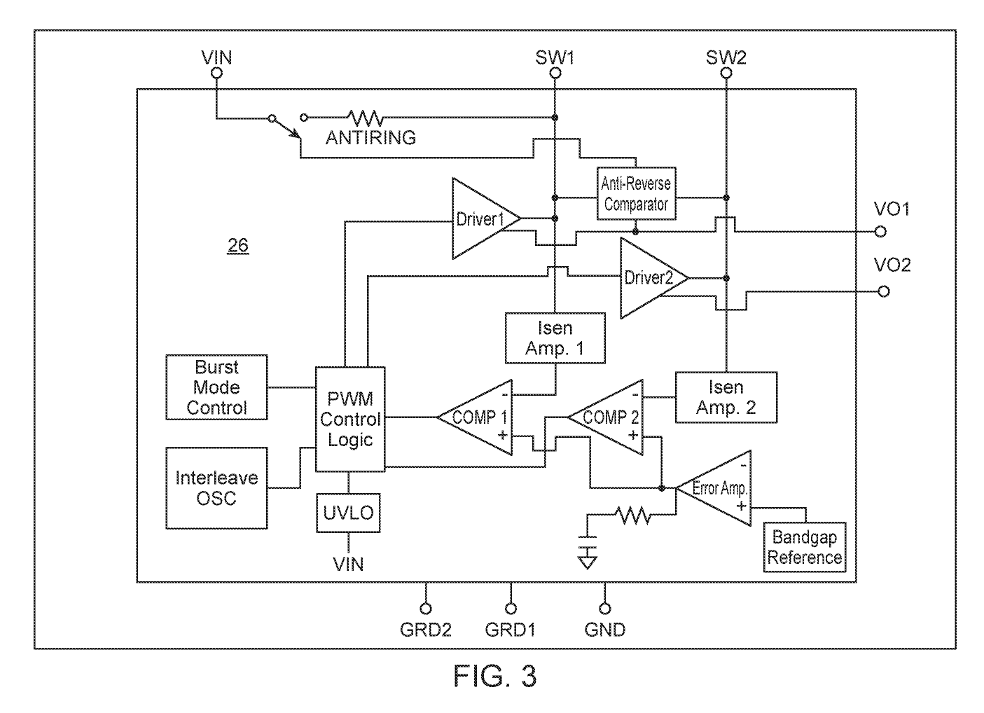

FIG. 2 shows a simplified schematic diagram illustrating a voltage regulation circuit 24, in accordance with many embodiments, that can be used in the voltage regulation controller 12. FIG. 3 shows a simplified schematic diagram illustrating an integrated circuit 26, in accordance with many embodiments, that can be used in the voltage regulation circuit 24. The voltage regulation circuit 24 and the integrated circuit 26 generate a regulated output voltage suitable to power a battery powered device from a battery output voltage even when the battery output voltage is below a suitable minimum voltage for a battery powered device. The battery voltage at the input voltage is connected to the input of a boost circuit that has a capacitor to ground and an input inductor connected to a Driver 1 and Driver 2 of the integrated circuit 26 that pulls the inductor to effective ground in order to store energy in the inductor from the input voltage. The switch turns off and the voltage developed across the inductor changes polarity and then the inductor voltage due to its on time of the switch is added to the battery voltage and processed through a synchronous field-effect transistor (FET) to Vout1 and Vout2. Vin voltage plus inductor voltage equals to Vout or output voltage of the circuit. The output voltage is controlled by control circuitry in the integrated circuit 26 that monitors the input battery voltage and output voltage of the circuit.

The voltage regulation circuit 24 generates a suitable output voltage (e.g., 1.1 to 1.5 volts) to power a battery powered device from a battery output voltage of 0.5 volts to 1.6 volts (a typical alkaline battery output voltage range). The battery voltage output range may vary depending on battery type. The voltage regulation circuit 24 can be configured for use with different battery types (e.g., a non-rechargeable battery, a rechargeable battery) to accomplish the same result, namely to power the battery powered device with a suitable voltage to properly operate the battery powered device while the battery is fully depleted to its minimum voltage.

In many embodiments, the integrated circuit 26 is configured to generate a suitable output voltage (e.g., 1.1 to 1.5 volts) from an battery output voltage in a range from 0.5 volts to 1.8 volts. Vout/Vinput=1/(1−D), where D is the duty cycle of Ton/Frequency of operation where V=L di/dt where is the voltage across the inductor during the part of the cycle where the Vin is switched across the inductor. In many embodiments, the voltage regulation circuit 24 is a synchronous circuit where a first field-effect transistor (FET) switches the inductor across the input voltage and a second FET rectifies the voltage to the output once the first FET is off, thereby outputting an output voltage that is boosted relative to the battery output voltage.

In many embodiments, the voltage regulation circuit 24 operates as a series regulator when the unit battery is fully charged at 1.55 Volts to 1.65 volts value when the battery is new and fully charged to its typical max voltage. Accordingly, the voltage regulation circuit 24 can pass the battery output voltage directly through to the output of the voltage regulation circuit 24 to maximize efficiency as the battery output voltage decreases from its initial fully charged voltage (e.g., 1.65 volts) down to a suitable lower but still adequate voltage such as, for example, any suitable adequate voltage from its nominal voltage (e.g., 1.5 volts) to a minimum voltage level adequate to properly power the applicable battery powered device (e.g., 1.2 volts). For example, as the output voltage changes from 1.65 to 1.5 volts, the reference can track at a percentage less then output voltage to maximize the efficiency from 1.65 to 1.5 volts. The series switch maximizes efficiency of the converter circuit and minimizes losses of the battery energy at initial battery output voltage of 1.65 volts to 1.5 volts. Once the battery is discharged to about 1.5 volts (which is rated voltage of an alkaline battery) the voltage regulation circuit 24 can be configured to generate an output voltage that is boosted relative to the battery output voltage. For example, the voltage regulation circuit 24 can generate an output voltage that is boosted relative to the battery output voltage while the battery output voltage decreases from 1.5 volts to where the battery is fully discharged at about 0.5 volts. In the illustrated embodiment, the voltage regulation circuit 24 can generate a suitable output voltage from a battery output voltage down to 0.5 volts, thereby serving to fully drain the battery of energy before replacement or recharging of the battery.

The voltage regulation circuit 24 can be configured to proportionately drop the output voltage of the voltage regulation circuit 24 from 1.5 volts to about 1.15 volts as the input voltage from the battery discharges from 1.5 volts to 0.50 volts output. Varying the output voltage in this manner can be done by varying the band gap reference in the integrated circuit 26. The integrated circuit 26 monitors the input voltage from the battery and changes the generated output voltage by changing the band gap reference value in order to reduce the output voltage. By varying the Volt reference in the integrated circuit 26 from a nominal 0.40 volts for a 1.5 volt input battery voltage and a 1.5 volt output to about 0.30 volts for 0.8 volts input battery voltage, the output voltage generated from the 0.8 volts input from the battery will be about 1.15 volts. The Volt reference in the integrated circuit 26 can be varied using several approaches and can be varied differently for different battery types.

Efficiency of the voltage regulation circuit 24 can be increased by increased by reducing the amount by which the voltage regulation circuit 24 boosts the battery supplied voltage. When the input voltage from the battery is down to 0.8 volts, the input current from the battery may be 1.875 times the current output from the voltage regulation circuit 24 when the voltage regulation circuit 24 generates a 1.5 volts output voltage from the 0.8 voltage. The input boost current is proportional to efficiency loss. If the output voltage generated from the 0.8 input voltage is reduced to about 1.15 volts then the input current value only 1.437 times the generated output current, thereby improving the efficiency due to the lower boost ratio. The savings in power loss is the square of 1.437/1.875. The battery life is thereby increased so the battery powered device can be powered by a given battery for a longer time before the battery is depleted of energy.

Efficiency of the voltage regulation circuit 24 can be increased in various ways for various types of batteries. The ratio of input voltage to generated output voltage can be varied depending on battery voltage when at full charge versus when fully discharged. For example, as the input voltage from the battery drops from a maximum of 1.6 volts to 0.80 volts, the voltage regulation circuit 24 can be configured to linearly reduce the generated output voltage from 1.55 volts to 1.1 volts or exponentially drop the generated output voltage or a combination of both ratios. In general, the generated output voltage can be made to be any suitable function of the input voltage from the battery so as to provide a desired combination of generated output voltage and overall battery life. Different variations can be realized by controlling the Band gap reference of the integrated circuit 26 to generate a desired output voltage for a given input voltage from the battery.

The voltage regulation circuit 24 is also configured to generate a suitable output voltage to functionally power a battery powered device during transients. For example, a large current draw may reduce the voltage input from the battery down to 0.50 volts and the voltage regulation circuit 24 will still generate a suitable output voltage to power the battery powered device

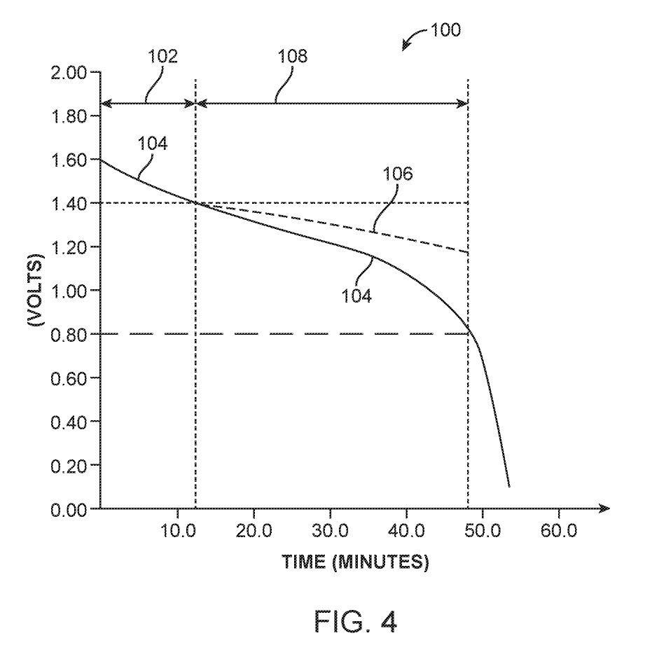

FIG. 4 illustrates a voltage regulation approach 100 utilizing both voltage pass through and voltage increase relative to battery output voltage, in accordance with many embodiments. During a bypass phase 102, a battery output voltage 104 is directly output by the voltage regulation circuit 24 to a battery powered device as described herein. The bypass phase is used where the battery output voltage 104 exceeds a first selected voltage level (e.g., 1.40 volts in the illustrated example). Any suitable voltage level can be used as the first selected voltage level. When the battery output voltage 104 is below the first selected voltage level, the voltage regulation circuit 24 generates a boosted voltage 106 from the battery output voltage during a boost phase 108. In the illustrated example, the boosted voltage 106 varies as a function of the battery output voltage 104 from 1.40 volts when the battery output voltage 104 is 1.40 volts down to 1.20 volts when the battery output voltage 104 is 0.80 volts. As described herein, by decreasing the voltage of the boosted output voltage 106 generated from the battery output voltage 104, the efficiency of the voltage regulation circuit 24 is improved thereby yielding increased effective battery life.

The voltage regulation circuit 24 has modes to switch operation depending on the amount of the current the load is drawing from the battery. For example, if the voltage regulation circuit 24 were to draw current from the battery even when no load is applied, the current drawn by the voltage regulation circuit 24 may have a negative impact on the useful life of the battery. To avoid such a negative impact, the voltage regulation circuit 24 can have a low current operational mode for when there is no load or a very small load, in which the voltage regulation circuit 24 draws a low current. In the low current operational mode, the overall draw of the current by circuit 26 drops to less than 20 uA, hereby referred to as standby current. In that way, the standby current of circuit 26 doesn't have a measureable impact on the total life of the battery given the normal loads are in 100's of mA.

Selectable and/or Programmable Pass Through Voltage Threshold

In some embodiments, the voltage regulation controller 12 is configured so that the regulated output voltage is equal to the input voltage when the input voltage is equal to or greater than a pass through voltage threshold. The battery life extension unit 10 can be configured so that the pass through voltage threshold is user selectable (e.g., via configuration switches defining which of preprogrammed pass through voltage thresholds to use as the pass through voltage threshold) and/or user programmable.

Selectable and/or Programmable Vin/Vout Lookup Table(s)

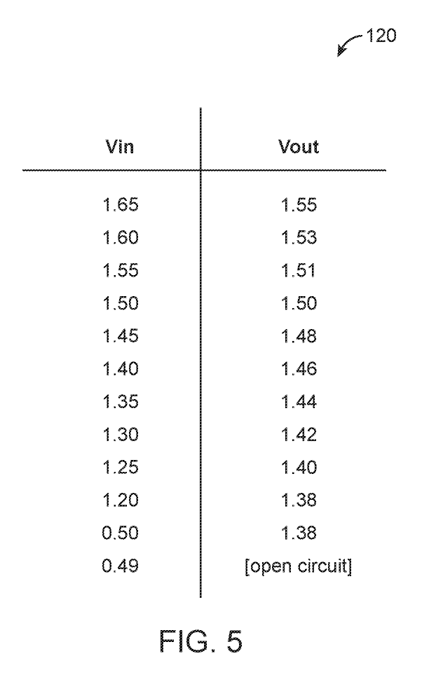

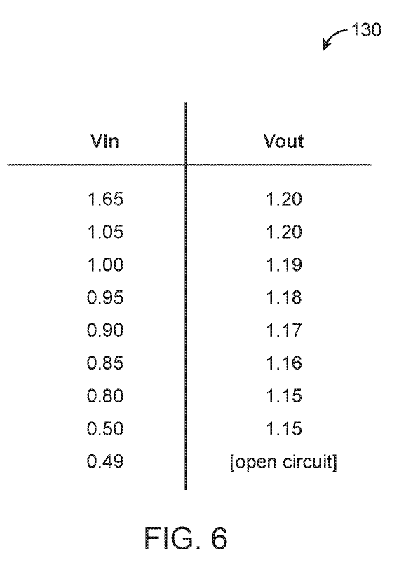

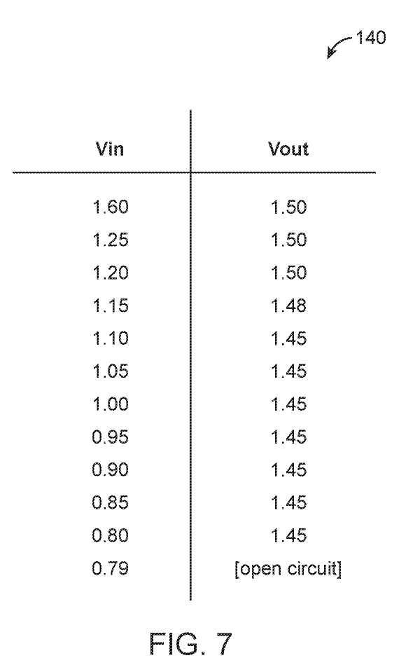

In some embodiments, the voltage regulation controller 12 is configured to control the regulated output voltage as a function of the input voltage in accordance with an output voltage lookup table, which can be stored in memory 14. FIG. 5 illustrates an example output voltage lookup table 120, in accordance with many embodiments, that can be used in the battery life extension unit 10 to control the level of Vout as a function of Vin. In the output voltage lookup table 120, the regulated output voltage is varied from 1.55 volts for an input voltage of 1.65 volts down to an output voltage of 1.38 volts for an input voltage of 0.50 volts. In the example output voltage lookup table 120, the output voltages are maintained at a relatively high level, which may be suitable for a passive-load type device, such as a flashlight. FIG. 6 illustrates another example output voltage lookup table 130, in accordance with many embodiments, that can be used in the battery life extension unit 10 to control the level of Vout as a function of Vin suitable for use in an active load condition. FIG. 7 illustrates another example output voltage lookup table 140, in accordance with many embodiments, that can be used in the battery life extension unit 10 to control the level of Vout as a function of Vin suitable for use with rechargeable batteries in a passive load condition. In the output voltage lookup table 140, the regulated output voltage is set to open circuit for input voltage levels of 0.79 volts or less so as to prevent discharge of the rechargeable battery below 0.80 volts to avoid damaging the rechargeable battery through over discharge. One or more output voltage lookup tables can be stored in the memory 14 either through preprogramming or via user programming. The battery life extension unit 10 can be configured to enable user selection of an output voltage lookup table stored in the memory 14 for use in controlling the generation of the regulated output voltage by the voltage regulation controller 12.

9 Volt Battery Replacement Assemblies

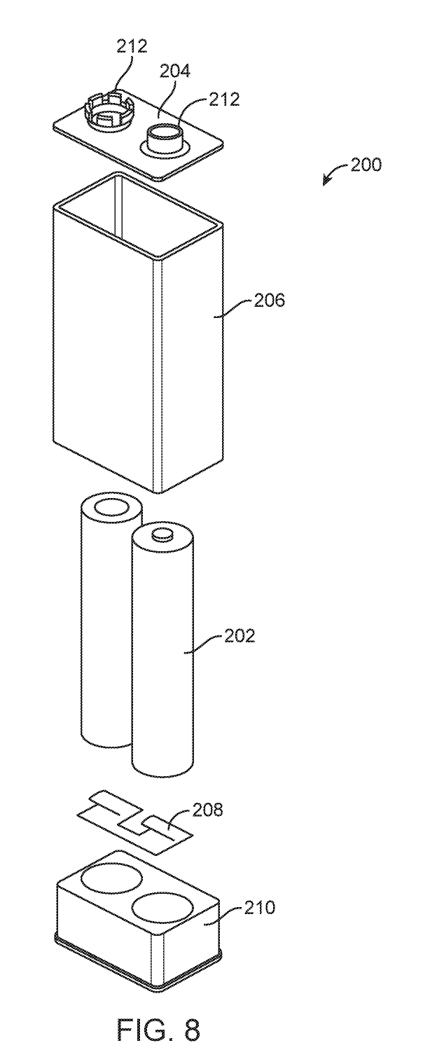

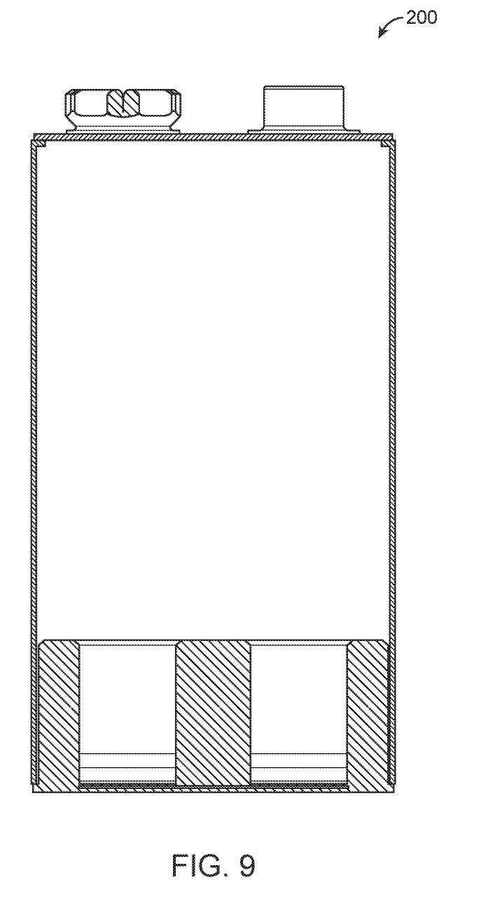

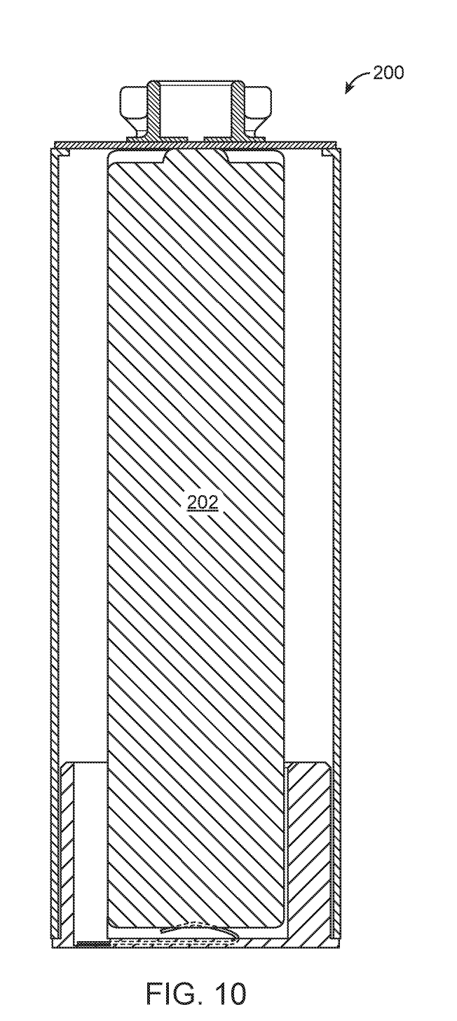

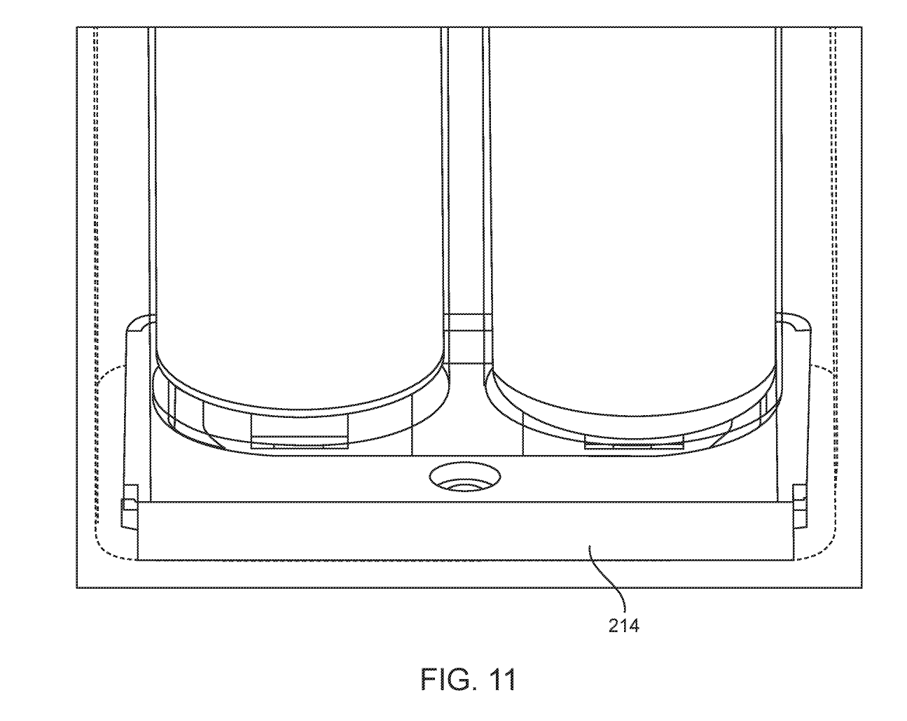

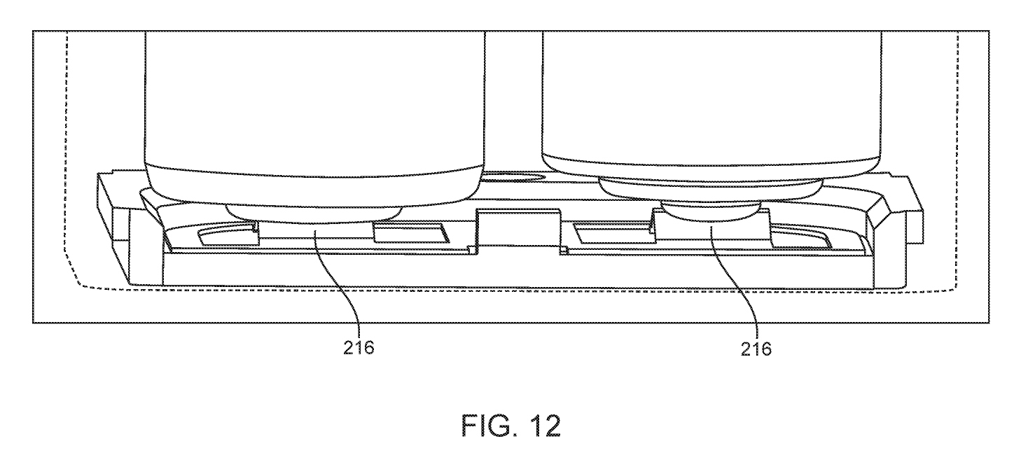

FIG. 8 shows an exploded view illustrating a 9 volt battery replacement assembly 200 that employs two AAA batteries 202 and a printed circuit board (PCB) 204 that includes a voltage-boosting regulation circuit, in accordance with many embodiments. The two AAA batteries 202 are connected in series thereby producing a nominal 3 volt output voltage. The voltage-boosting regulation circuit is configured similar to the voltage regulation circuit 24, but is configured to boost the nominal 3 volt output voltage up to a nominal 9 volt output voltage using a similar boosting approach. The voltage-boosting regulation circuit is also configured to further boost the output voltage from the two serially-connected batteries 202 to compensate for voltage output drop of the batteries 202 that occurs during discharge of the batteries 202 as described herein with respect to the voltage regulation circuit 24. The 9 volt battery replacement assembly 200 further includes an outer shell 206 in which the batteries 202 are enclosed, an electrical connection assembly 208 that serially connects the batteries 202, a bottom cover 210 shaped to be slidingly received into the outer shell 206 and into which ends of the batteries 202 are accommodated, and battery output terminals 212 mounted to the PCB 204 that are similar to standard 9 volt battery output terminals. FIG. 9 shows a cross-sectional view of the 9 volt battery replacement assembly 200. FIG. 10 shows a side view of the 9 volt battery replacement assembly 200. FIG. 11 illustrates a 9 volt battery replacement assembly that includes a sliding bottom cover 214, in accordance with many embodiments. FIG. 12 illustrates contacts 214 designed to allow the sliding bottom cover 214 of FIG. 11 to slide in from the side.

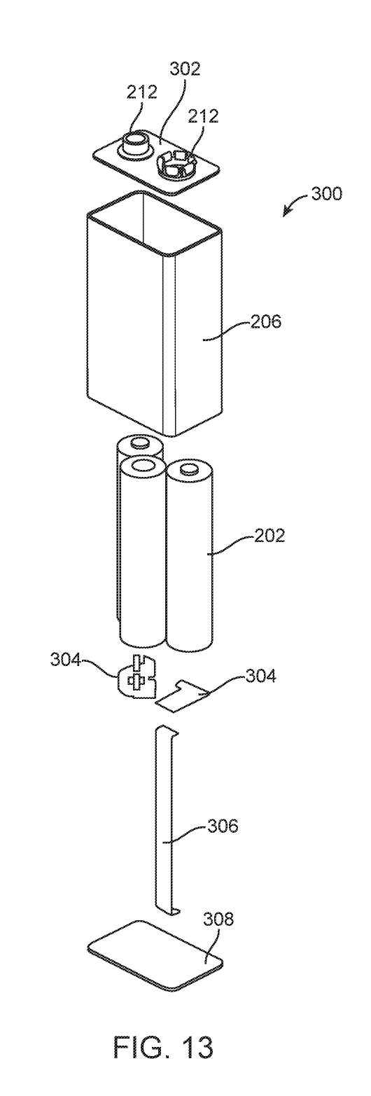

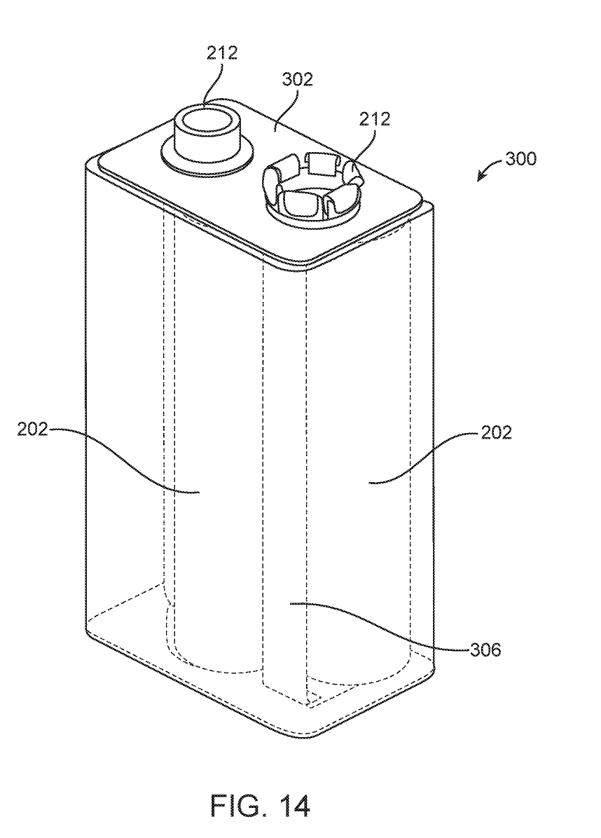

FIG. 13 shows an exploded view illustrating a 9 volt battery replacement assembly 300 that employs three AAA batteries 202 and a printed circuit board (PCB) 302 that includes a voltage-boosting regulation circuit, in accordance with many embodiments. The three AAA batteries 202 are connected in series thereby producing a nominal 4.5 volt output voltage. The voltage-boosting regulation circuit is configured similar to the voltage regulation circuit 24, but is configured to boost the nominal 4.5 volt output voltage up to a nominal 9 volt output voltage using a similar boosting approach. The voltage-boosting regulation circuit is also configured to further boost the output voltage from the three serially-connected batteries 202 to compensate for voltage output drop of the batteries 202 that occurs during discharge of the batteries 202 as described herein with respect to the voltage regulation circuit 24. The 9 volt battery replacement assembly 300 further includes an outer shell 206 in which the batteries 202 are enclosed, electrical connectors 304 and a flexible electrical connector 306 that serially connects the batteries 202, a bottom cover 308 shaped to be slidingly received by the outer shell 206, and battery output terminals 212 mounted to the PCB 302 that are similar to standard 9 volt battery output terminals. FIG. 14 is a three-dimensional partially-transparent view illustrating the 9 volt battery replacement assembly 300.

C and D Size Battery Replacement Assemblies

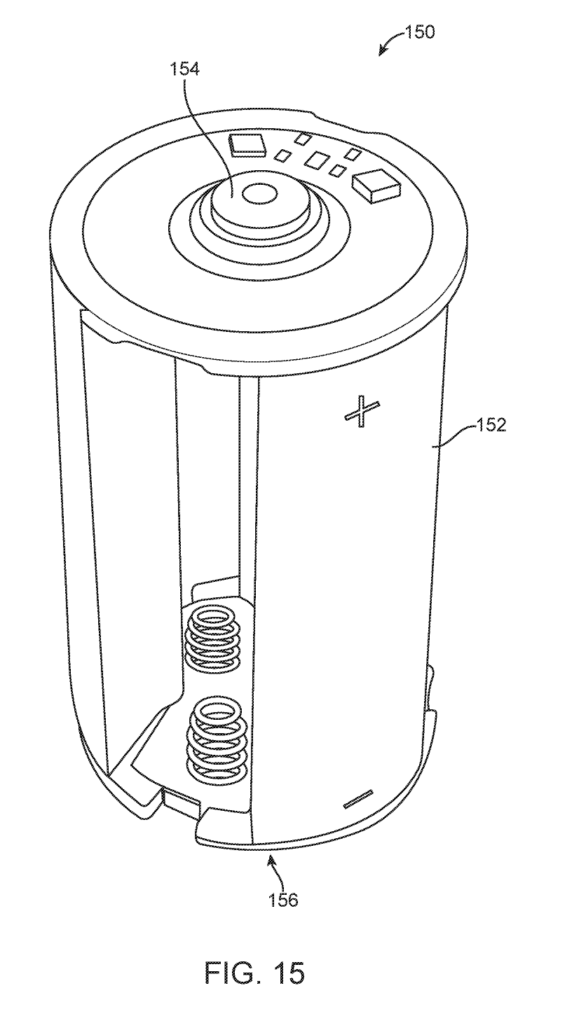

FIG. 15 illustrates a battery replacement assembly 150 that employs three AA batteries and includes a voltage-boosting regulation unit, such as the battery life extension unit 10, in accordance with many embodiments. The battery replacement assembly 150 is sized to match the size of a D size battery. The battery replacement assembly 150 includes a shell 152 forming slots for three AA batteries. In the illustrated embodiment, the three AA batteries are organized and connected in parallel and the resulting voltage output of the three AA batteries is connected to the input of the voltage-boosting regulation unit. As the voltage of the three AA batteries is reduced due to current draw, the output voltage of the voltage-boosting regulation unit can be regulated using any suitable approach, such as those described herein for the battery life extension unit 10. The battery replacement assembly 150 includes a positive output terminal 154 and a ground output terminal 156 for supplying the regulated output voltage to a battery powered device. The positive output terminal 154 and the ground output terminal 156 are attached to the shell 152 to be positioned to match the position of corresponding D size battery positive and ground terminals.

In an alternate embodiment, a battery replacement assembly for replacing a C size battery can be configured similar to the battery replacement assembly 150. The battery replacement assembly for replacing a C size battery can employ four AAA batteries and include a voltage-boosting regulation unit, such as the battery life extension unit 10, in accordance with many embodiments. The battery replacement assembly for replacing a C size battery can include a shell, configured similar to the shell 152, but forming slots for four AAA batteries. The four AAA batteries can be organized and connected in parallel and the resulting voltage output of the four AAA batteries is connected to the input of the voltage-boosting regulation unit. As the voltage of the four AAA batteries is reduced due to current draw, the output voltage of the voltage-boosting regulation unit can be regulated using any suitable approach, such as those described herein for the battery life extension unit 10. The battery replacement assembly for replacing a C size battery can include a positive output terminal (similar to the positive output terminal 154) and a ground output terminal (similar to the ground output terminal 156) for supplying the regulated output voltage to a battery powered device. The positive output terminal and the ground output terminal are attached to the shell to be positioned to match the position of corresponding C size battery positive and ground terminals.

Battery Assembly with Reusable Battery Life Extension Unit

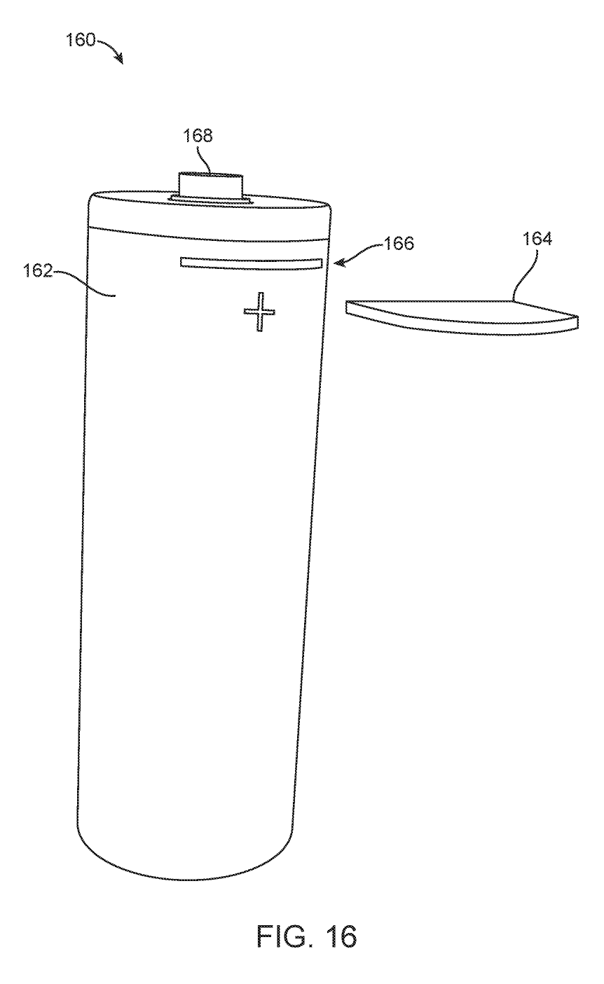

FIG. 16 shows a battery assembly 160 that includes a battery cell assembly 162 and a reusable voltage-boosting regulation unit 164, in accordance with many embodiments. The reusable voltage-boosting regulation unit 164 can have any suitable configuration, such as that of the battery life extension unit 10. In the illustrated embodiment, the regulation unit 164 is sized and shaped similar to a secure digital (SD) card and the battery cell assembly 162 has a slot 166 into which the regulation unit 164 is inserted and from which the regulation unit 164 can be removed to allow insertion into another battery cell assembly 162. By enabling reuse of the regulation unit 164 with different battery cell assemblies 162, significant savings are possible. In many embodiments, the regulation unit 164 is sufficiently expensive so as to be expensive to use one time. By making the regulation unit 164 removable and reusable, the cost of the battery cell assembly 162 can be kept low. The battery cell assembly 162 can come with a dummy card inserted into the slot 166. The dummy card can be configured to electrically connect the internal battery cell of the battery cell assembly 162 to the positive output terminal 168. The dummy card can be removed from the slot 166 to allow insertion of the regulation unit 164 into the slot 166. Once the regulation unit 164 is inserted into the slot 166, the output of the internal cell of the battery cell assembly 162 is connected to the Vin of the regulation unit 164 and the regulated voltage output of the regulation unit 164 is coupled with the positive output terminal 168.

Battery Life Extending Sleeves

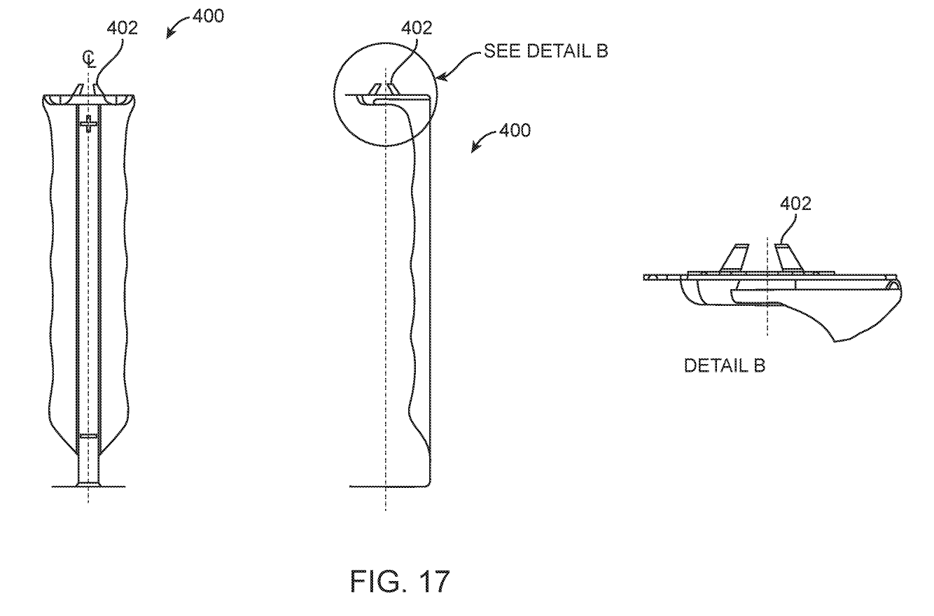

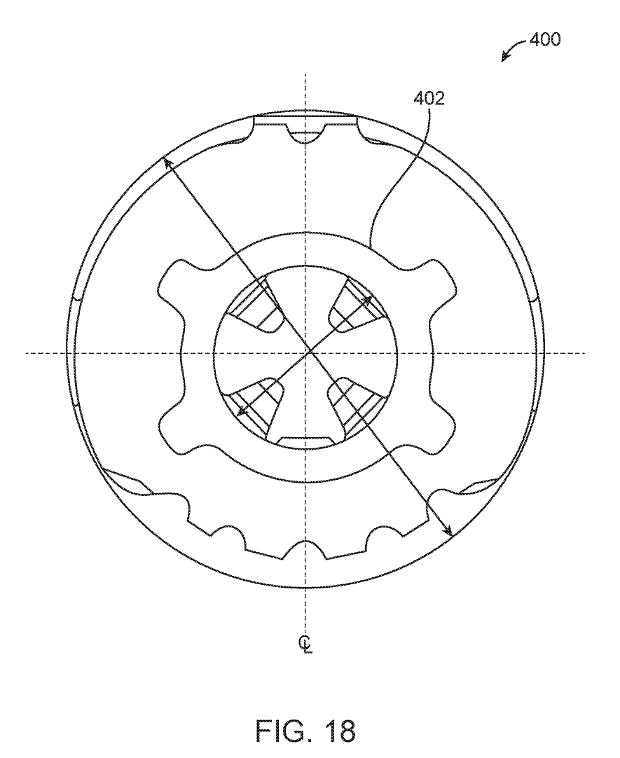

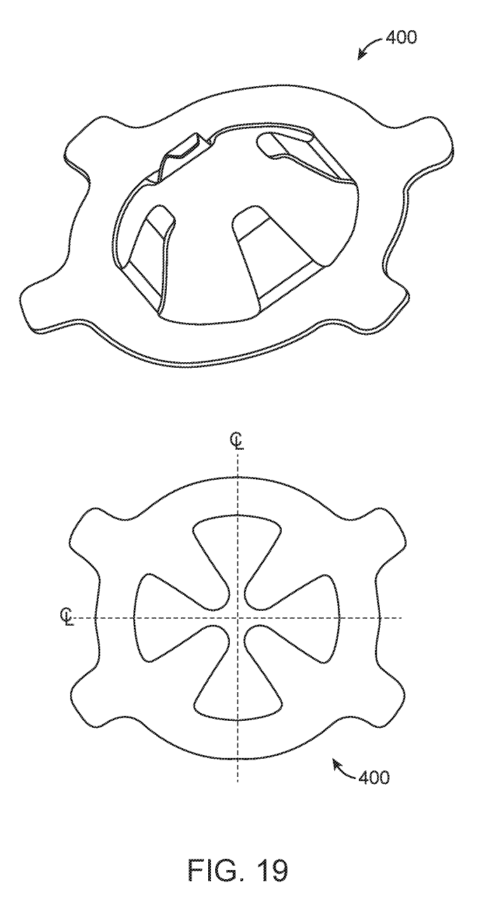

FIG. 17 illustrates a voltage regulating battery sleeve 400, in accordance with many embodiments. The voltage regulating battery sleeve 400 includes a printed circuit board that includes the voltage regulating circuit 10 as described herein. The voltage regulating battery sleeve 400 includes a Flexible Electrical Contact (FEC) 402 made from a suitable conductive sheet material. FIG. 18 shows a top view of the battery sleeve 400. FIG. 19 illustrates the FEC 402 in an undeflected configuration and a flat configuration. The purpose of the Flexible Electrical Contact (FEC) is to provide the contact where there is only one battery used, while reducing the overall added height due to sleeves when there are multiple batteries used in series. In order to protect against batteries being installed backwards, manufacturers of devices have devised contacts for the positive side of the battery that protrude from the body of the battery. That way, if the battery is installed backwards, the flat side of the battery (negative terminal) will not contact the mating positive contact of the device due to lack of protrusion of the negative terminal of the battery. The FEC provides the protruding positive terminal in cases where a battery is encapsulated by the sleeve 400. The extra height of added to the battery is self-regulated by the FEC due to the flexibility of the FEC. Also, in cases where there are multiple batteries stacked on top of each other, the extra height would get multiplied if the protruding positive terminals were hard and non-flexible. The flexibility of the FEC functions to avoid the additional height because the FEC for the sleeve encapsulating the lower batteries can flatten out due to flexing, while still maintaining contact to the bottom of the adjacent upper battery without significantly adding to the overall height of the multiple battery solution.

FIG. 18 further shows the entire sleeve 400 including the top FEC 402. One other feature of the sleeve 400 is that while a section of the sleeve 400 that runs between the top and the bottom and surrounds the body of the battery can be conductive to transfer the ground voltage from the bottom to the top, it may have potential issues in some configurations if it was to conduct to the external circuitry. This section of the body of the sleeve can be coated with an anti-conductive coating to avoid any potential unintended contacts to external circuitry that is utilizing a battery with sleeve 400. The coating can be applied by an ED (electro-deposited) process in order to ensure coating of all intended surfaces. This coating can also cover all bend radii of the sleeve to account for manufacturing tolerances of the metal sleeve and assembly process which would otherwise leave potential exposed metal areas that may short to features within the device that the sleeve assembly is installed in.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A battery life extension unit, comprising:
a voltage-boosting regulation circuit configured to produce a regulated output voltage from an input voltage supplied by a battery cell, the regulated output voltage being greater than the input voltage when the input voltage is less than a predetermined voltage;
a positive output terminal configured to supply the regulated output voltage to a battery powered device;
a positive input terminal configured to receive the input voltage from the battery cell; and
a ground input terminal electrically coupled with the voltage-boosting regulation circuit.

2. The battery life extension unit of claim 1, wherein the voltage-boosting regulation circuit is configured so that the regulated output voltage is equal to or greater than 1.2 volts when the input voltage is about 0.5 volts.

3. The battery life extension unit of claim 2, wherein the voltage-boosting regulation circuit is configured so that the regulated output voltage is equal to or greater than 1.4 volts when the input voltage is about 0.5 volts.

4. The battery life extension unit of claim 1, further comprising a support frame, and wherein:
the positive output terminal is attached to the support frame so as to be positioned, relative to a ground terminal of the battery cell, to interface with a positive input terminal of the battery powered device to supply the regulated output voltage to the battery powered device when a ground input terminal of the battery powered device is interfaced with the ground terminal of the battery cell;
the positive input terminal is attached to the support frame so as to be positioned, relative to the ground terminal of the battery cell, to interface with a positive terminal of the battery cell to receive the input voltage when the ground input terminal of the battery powered device is interfaced with the ground terminal of the battery cell; and
the ground input terminal is attached to the support frame so as to be positioned to interface with the ground terminal of the battery cell when the ground input terminal of the battery powered device is interfaced with the ground terminal of the battery cell.

5. The battery life extension unit of claim 1, further comprising a tangible memory device storing an output voltage lookup table defining the regulated output voltage as a function of the input voltage.

6. The battery life extension unit of claim 5, wherein the output voltage lookup table is programmable by a user of the battery life extension unit.

7. The battery life extension unit of claim 1, further comprising a tangible memory device storing (a) an active-load device output voltage lookup table defining the regulated output voltage, as a function of the input voltage, so as to be suitable for operation of an active-load battery powered device, and (b) a passive-load device output voltage lookup table defining the regulated output voltage, as a function of the input voltage, so as to be suitable for operation of a passive-load battery powered device.

8. The battery life extension unit of claim 7, wherein:
the active-load device output voltage lookup table defines the regulated output voltage to be in a range of 1.1 volts to 1.4 volts when the input voltage is in a range of 0.8 volts to 1.6 volts; and
the passive-load device output voltage lookup table defines the regulated output voltage to be equal to or greater than 1.4 volts when the input voltage is in a range of 0.8 volts to 1.6 volts.

9. The battery life extension unit of claim 1, wherein a user can select from a plurality of operational modes including:
a non-rechargeable battery operational mode suitable for use with a non-rechargeable battery, and
a rechargeable battery operational mode suitable for use with a rechargeable battery, the rechargeable battery operational mode having a rechargeable battery stop input voltage level that prevents discharge of the rechargeable battery below the rechargeable battery stop input voltage level.

10. The battery life extension unit of claim 1, wherein the regulated output voltage is equal to the input voltage when the input voltage is above a pass-through voltage threshold.

11. The battery life extension unit of claim 10, wherein the pass-through voltage threshold is programmable by a user of the battery life extension unit.

12. The battery life extension unit of claim 1, further comprising a wireless communication unit operable to transmit at least one of: (a) a state of charge of the battery cell, and (b) an estimated time remaining for operation of the battery powered device via power supplied by the battery cell.

13. The battery life extension unit of claim 12, wherein the wireless communication unit is operable to:
receive data from the battery powered device; and
transmit the data received from the battery powered device.

14. The battery life extension unit of claim 1, configured to be removably connectable to a battery cell to enable reuse with at least two different battery cells.

15. A 9 volt battery replacement assembly, comprising:
a voltage-boosting regulation circuit configured to produce a 9 volt output voltage from two or more 1.5 volt batteries;
an outer shell configured to at least partially enclose the two or more 1.5 volt batteries; and
positive and negative terminals configured to interface with a 9 volt input connector of an electrical device configured to be powered by a 9 volt battery.

16. A battery replacement assembly for replacing a D size battery, the battery replacement assembly comprising:
a voltage-boosting regulation circuit configured to produce a regulated output voltage from an input voltage supplied by three AA size batteries connected in parallel, the regulated output voltage being greater than the input voltage when the input voltage is less than a predetermined voltage;
an outer shell configured to at least partially enclose the three AA size batteries; and
positive and negative output terminals for outputting the regulated output voltage, the positive and negative output terminals being attached to the shell so as to be positioned to match positioning of positive and negative output terminals for a D size battery.

17. A battery replacement assembly for replacing a C size battery, the battery replacement assembly comprising:
a voltage-boosting regulation circuit configured to produce a regulated output voltage from an input voltage supplied by four AAA size batteries connected in parallel, the regulated output voltage being greater than the input voltage when the input voltage is less than a predetermined voltage;
an outer shell configured to at least partially enclose the four AAA size batteries; and
positive and negative output terminals for outputting the regulated output voltage, the positive and negative output terminals being attached to the shell so as to be positioned to match positioning of positive and negative output terminals for a C size battery.

18. A battery life extending sleeve, comprising:
a voltage-boosting regulation circuit;
a sleeve being configured to electrically connect positive and negative terminals of a battery to the voltage-boosting regulation circuit; and
a Flexible Electrical Contact (FEC) electrically connected to a positive voltage output of the voltage-boosting regulation circuit, the FEC being configured to flex toward the sleeve when interfaced with a mating terminal to accommodate the position of the mating terminal.
